(19) United States
(12) Patent Application Publication
(10) Pub. No.: US 2004/0012133 A1
(43) Pub. Date: Jan. 22, 2004

(54) Device for damping jerks in a rope

(76) Inventors: David Sandahl, Hassleholm (SE); Martin Skold, Skarpnack (SE)

Correspondence Address: HARNESS, DICKEY & PIERCE, P.L.C., P.O. BOX 8910, RESTON, VA, 20195, US

(21) Appl. No.: 10/276,093

(22) PCT Filed: May 16, 2001
(86) PCT No.: PCT/SE01/01070

(30) Foreign Application Priority Data
May 24, 2000 (SE) 0001932-3

(51) Int. Cl. F16M 1/00

(52) U.S. Cl. 267/136

(57) ABSTRACT

A device for damping jerks in a rope (2) comprises a ring (3) made of a resilient material, into the hole (4) of which a loop (2a) of the rope is to be introduced in order to be arranged on the ring in such manner that the ring is elastically deformed when a pulling force is exerted on the rope. The ring (3) has a projection (5), which is formed in one piece with the ring and protrudes from the outside of the ring. The projection is arranged to hook the rope loop introduced into the hole (4) of the ring onto its portion closest to the ring (3) to cause a turning-inside-out-like, elastic deformation of the ring (3) when a pulling force is exerted on the rope (2).

### FIELD OF THE INVENTION

The present invention relates to a device for damping jerks in a rope, which device comprises a ring made of a resilient material, into the hole of which a loop of the rope is to be introduced in order to be arranged on the ring in such manner that the ring is elastically deformed when a pulling force is exerted on the rope.

### BACKGROUND ART

A device of this type is known from WO99/15806. In this device, the ring consists of an elongated, substantially rectangular frame, which is made of a resilient material and into the similarly substantially rectangular centre hole of which a U-shaped portion of a rope is to be introduced. The device further has a crossbar, which is pivotally attached to the outside of one of the longer frame side parts. The crossbar is formed in one piece with the frame and is pivotable between a mounting position, in which it extends away from the frame, and an operating position, in which it extends across the hole of the frame and abuts against the two longer frame side parts of the frame. When the rope is introduced into the hole, the crossbar is in the mounting position. The U-shaped loop of the rope is introduced far enough for the crossbar to be pivoted through the loop to its operating position. Once this is done, the loop is retracted far enough for the U-shaped portion of the rope to abut against the crossbar, which thus extends through the loop. The rope thus extends in the longitudinal direction of the frame and also abuts against the inside of the shorter frame side parts of the frame. When a pulling force is exerted on the rope, the abutment of the rope against the shorter frame side parts of the frame causes these parts to be pressed away from each other, which results in the frame being resiliently stretched in its longitudinal direction.

A disadvantage of this prior-art device is its fairly complex construction, which makes it difficult and expensive to manufacture. Another disadvantage is that, as described above, mounting the device on a rope is a relatively lengthy process. A further disadvantage is that the portion of the rope on which the device is arranged is relatively short, which means that the damping of a jerk in the rope is limited.

### SUMMARY OF THE INVENTION

The object of the present invention is to provide a device for damping jerks in a rope, in which the above disadvantages of the device according to prior art have been eliminated.

This object is achieved by means of a device of the type described by way of introduction, characterised in that the ring has a projection, which is formed in one piece with the ring and protrudes from the outside of the ring and which is arranged to hook the rope loop introduced into the hole of the ring onto its portion closest to the ring to cause a turning-inside-out-like, elastic deformation of the ring when a pulling force is exerted on the rope.

The projection advantageously has a rope-receiving groove in the portion of the projection closest to the ring. Preferably, this groove has a shape complementary to a part of the ring's cross-section, at least in the portion of the ring that is “diametrically” opposed to the projection.

In a preferred embodiment, the ring is substantially plane. The ring is here suitably substantially D-shaped, with the projection protruding from the curved part of the D. The projection is preferably located substantially in the same plane as the ring.

### BRIEF DESCRIPTION OF THE DRAWINGS

The invention will now be described in more detail with reference to the accompanying drawings, in which

FIG. 1 is a perspective view of a device according to the invention mounted on a rope;

FIG. 2 is a view of the device taken in the direction of the arrow II in FIG. 1;

FIG. 3 is a front view of the device; and

FIG. 4 is a top view of the device.

### DESCRIPTION OF A PREFERRED EMBODIMENT

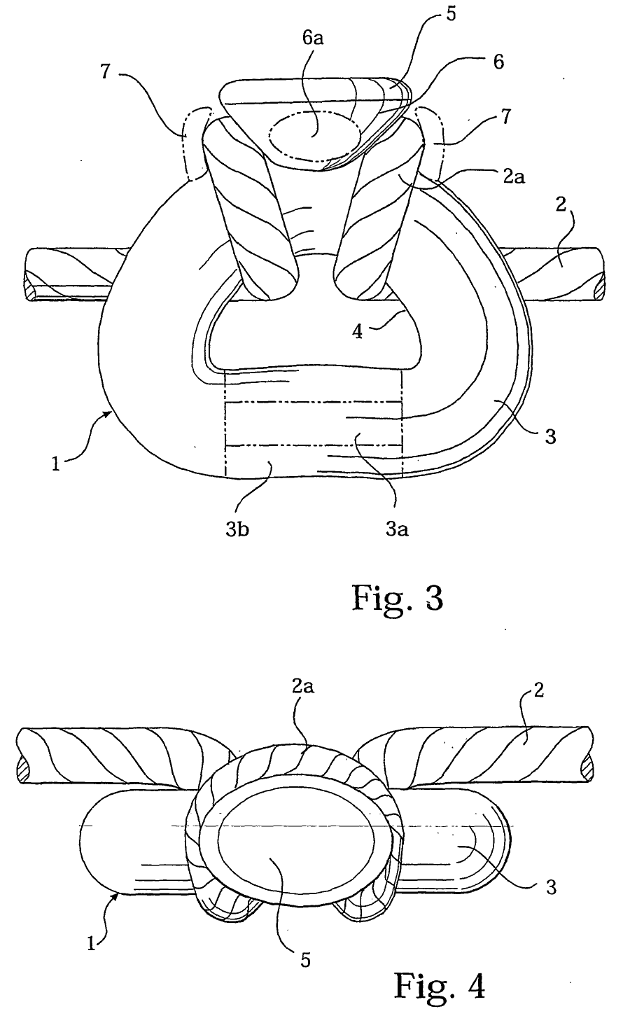

The device 1 for damping jerks in a rope 2, as shown in the drawings, is made of a resilient material, such as rubber. The device 1 has a substantially plane ring 3, which in a plane view (see FIG. 3) is shaped like a D. The hole 4 of the ring 3 is also D-shaped. The ring 3 is circular in cross-section. In the embodiment shown, the rope 2 is a cord but could be a rope of an optional type, for example a cable or a chain.

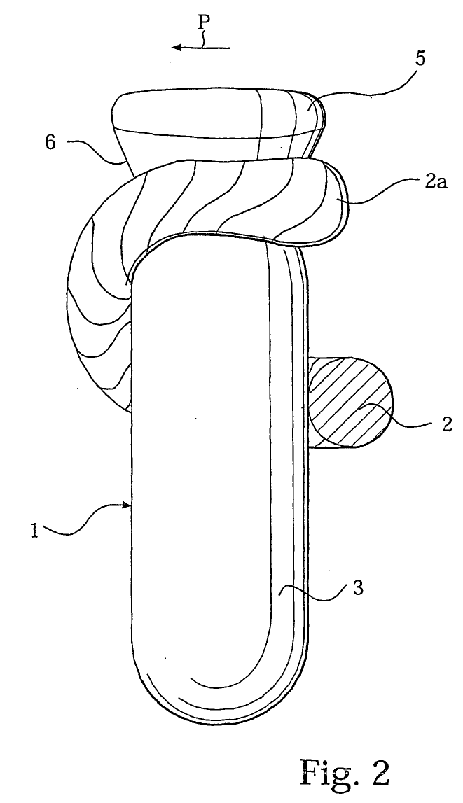

The device 1 further comprises a projection 5 formed in one piece with the ring 3 and protruding “radially” from the outside of the curved part of the D-shaped ring 3. The projection 5 is located in the centre of this curved part and in the same plane as the ring 3 (see FIG. 2).

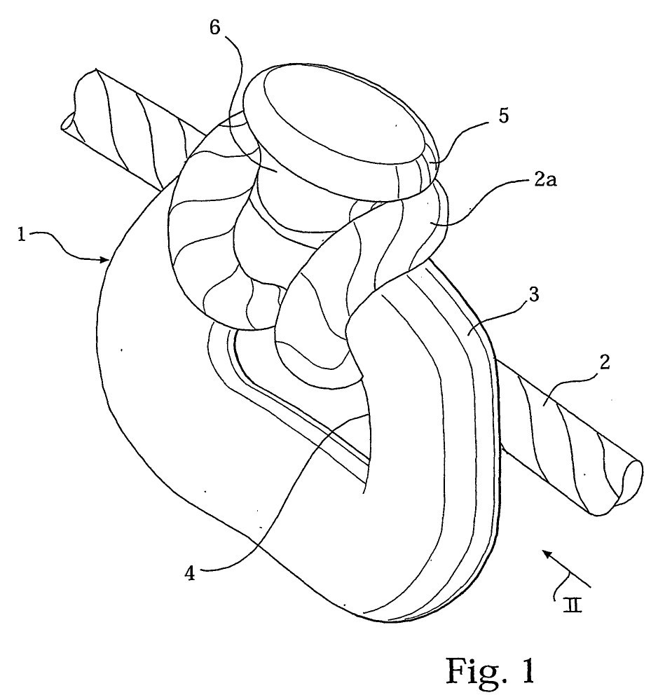

In the portion closest to the ring 3, the projection 5 has a circumferential groove 6 for receiving the rope 2. In its front-facing portion 6a (left-facing in FIG. 1), the groove 6 has a cross-sectional shape that is complementary to the front-facing part 3a of the cross-section of the ring 3 in the portion 3b of the ring that is “diametrically” opposed to the projection 5 (see FIG. 3). This means that the part 3a of the ring's 3 cross-section fits in the front-facing portion 6a of the groove 6 and can be received therein as the ring 3, due to the pulling action on the rope 2, is elastically deformed in the way specified below and the projection 5 is bent forwards in the direction of the arrow P in FIG. 2. It should be noted that the ring 3 in the embodiment shown has the same cross-sectional shape along its entire extension.

When the device 1 is mounted on the rope 2, a U-shaped portion 2a of the rope 2 is inserted from behind (from the right in FIG. 2) into the hole 4 of the ring 3 and then bent backwards so as to be hooked onto the projection 5 in the way illustrated in the drawings.

When a pulling force is exerted on the rope 2, for example as a result of a jerk in the rope, a turning-inside-out-like, elastic deformation of the ring 3 takes place in that the projection 5 is bent by the rope 2 in the direction of the arrow P (FIG. 2). This results in a soft damping of the jerk in the rope 2 causing the pulling force. If the jerk is strong enough, the ring 3 will be “turned” to such an extent that the projection 5 in the area of its groove portion 6a will abut against the part 3a of the portion 3b of the ring 3. Once this has occurred, the ring 3 cannot be “turned” any further, and the soft damping therefore changes to a slightly harder or more rigid damping caused by deformation of the projection 5 itself. When the pulling force or the jerk in the rope 2 stops, the device 1 resumes its original shape as shown in the drawings.

The circumferential groove 6 in the projection 5 retains the rope 2 in its position on the device 1 and reduces the risk of the rope loop 2a sliding off the projection 5 in case there is a slack in the rope 2. To further reduce this risk, the ring 3 may be provided with protruding tongues 7, in the way illustrated by dashed lines in FIG. 3, said tongues being arranged on both sides of the projection 5 to resiliently abut against the rope loop 2a and retain the loop in the groove 6 of the projection 5.

The device 1 shown in the drawings is intended especially to damp jerks in a rope used to moor a boat, a jetty or the like. The device 1 may also be used, or adapted to be used, in water-skiing, for example, or any similar sports activity where it may be useful to damp jerks in a hauling rope. A device according to the invention may also be used to damp jerks in a towline intended for towing vehicles. A device according to the invention may further be used in a ski lift apparatus to damp the jerk introduced in a hauling rope integrated therewith when an immobile skier grabs hold of the hauling rope to be transported by the lift apparatus. Naturally, it is also possible to use the device according to the invention in other applications where damping of jerks in a rope is required.

The embodiment as described above and shown in the drawings may be modified in many different ways within the scope of the claims set out below. For example, the ring 3 does not have to be D-shaped, but can have a different ring shape, for instance circular or oval shape. It can also be given a cross-sectional shape other than circular and need not necessarily have the same cross-section along its entire extension. The projection 5 may extend from the ring 3 at an angle relative to the plane of the ring.

1. A device for damping jerks in a rope (2), which device comprises a ring (3) made of a resilient material, into the hole (4) of which a loop (2a) of the rope is to be introduced in order to be arranged on the ring in such manner that the ring is elastically deformed when a pulling force is exerted on the rope, characterised in that the ring (3) has a projection (5), which is formed in one piece with the ring and protrudes from the outside of the ring and which is arranged to hook the rope loop (2a) introduced into the hole (4) of the ring onto its portion closest to the ring (3), to cause a turning-inside-out-like, elastic deformation of the ring (3) when a pulling force is exerted on the rope (2).

2. A device according to claim 1, wherein the projection (5) has a rope-receiving groove (6) in said portion.

3. A device according to claim 2, wherein the rope-receiving groove (6) has a shape complementary to a part (3a) of the ring's (3) cross-section, at least in the portion (3b) of the ring (3) that is “diametrically” opposed to the projection (5).

4. A device according to any one of claims 1-3, wherein the ring (3) is substantially plane.

5. A device according to claim 4, wherein the ring (3) is substantially D-shaped, with the projection (5) protruding from the curved part of the D.

6. A device according to claim 4 or 5, wherein the projection (5) is located substantially in the same plane as the ring (3).
